(19) United States
(12) Patent Application Publication
(10) Pub. No.: US 2020/0375003 A1
(43) Pub. Date: Nov. 26, 2020

(54) LINEAR CONSTANT-CURRENT LED DRIVE CIRCUIT ADAPTIVE TO WIDE VOLTAGE RANGE

(71) Applicant: Guizhou University, Guiyang, Guizhou (CN)

(72) Inventors: Kui MA, Guiyang, Guizhou (CN); Fashun YANG, Guiyang, Guizhou (CN); Shanghan YANG, Guiyang, Guizhou (CN); Zhuang WANG, Guiyang, Guizhou (CN)

(21) Appl. No.: 16/619,775

(22) PCT Filed: Apr. 28, 2019
(86) PCT No.: PCT/CN2019/084788

§ 371 Date: Dec. 5, 2019

(30) Foreign Application Priority Data
Sep. 14, 2018 (CN) 201811071817.2

(51) Int. Cl. H05B 45/44; H05B 45/345

(52) U.S. Cl. CPC H05B 45/44; H05B 45/345

(57) ABSTRACT

A linear constant-current LED drive circuit adaptive to a wide voltage range includes a rectifier bridge used for full-wave rectification of the waveform of a sinusoidal voltage and connected with a filter circuit and a high-voltage stabilizing and dropping circuit through wires, the filter circuit used for converting a full-wave pulsating voltage output by the rectifier bridge into a direct-current voltage and connected with a constant-current source circuit through a wire, the constant-current source circuit used for limiting a current across LED loads and providing a constant-current power supply for LED lights and connected with a switch array circuit through a wire, and the switch array circuit used for switching series-parallel connection modes of LED light strings by means of the switching characteristics of LDMODs when an external voltage varies. The high-voltage stabilizing and dropping circuit provides a working voltage for low-voltage modules. The technical problem of waste caused by insufficient utilization of LEDs in the prior art is solved.

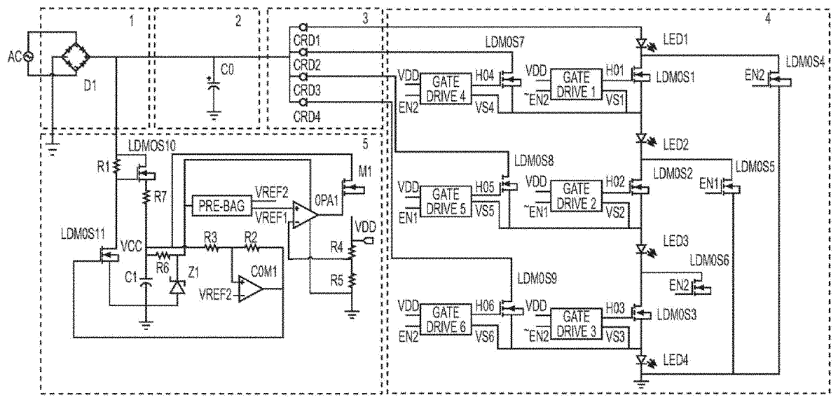

### BACKGROUND OF THE INVENTION

### 1. Technical Field

The invention belongs to the technical field of integrated circuits, and particularly relates to a linear constant-current LED drive circuit adaptive to a wide voltage range.

### 2. Description of Related Art

As a fourth-generation light source, LEDs which are high in luminous efficiency, long in service life, and free of pollution possess all the characteristics necessary for realizing efficient illumination. LED drive power supplies, serving as the key constituent part of LED lights, play a crucial role in the performance and service life of the lights. With the rapid development of linear constant-current LED drive power supplies in recent years, traditional linear constant-current drive power supplies have been replaced by high-voltage linear constant-current drive power supplies, which in turn have been replaced by segmented linear constant-current drive power supplies. There are currently two main types of mainstream segmented linear constant-current drive power supplies, wherein according to one type of the mainstream segmented linear constant-current drive power supplies, an LED array is segmented by means of the voltage clamp function of LEDs fulfilled when the LEDs are turned on forward, and the number of the LEDs connected to the circuit varies accordingly when the voltage pulsates after rectification, so as to keep the voltage across the two terminals of multiple LED light strings approximately consistent with an input voltage all the time; and according to the other type of the segmented linear constant-current drive power supplies, a rectifier bridge is formed by four LEDs by means of the forward-on and reverse-off characteristics of the LEDs, and when a network voltage passes through the rectifier bridge formed by the LEDs, power is directly supplied to two LEDs. However, both types of the segmented linear constant-current drive power supplies have the shortcoming of insufficient utilization of the LEDs, thus, causing waste.

### BRIEF SUMMARY OF THE INVENTION

The technical issue to be settled by the invention is to provide a linear constant-current LED drive circuit adaptive to a wide voltage range so as to solve the technical problem of waste caused by insufficient utilization of LEDs of the two types of segmented linear constant-current LED drive power supplies, mentioned in the prior art, which are respectively designed as follows: as for one type, an LED array is segmented by means of the voltage clamp function of LEDs when the LEDs are turned on forward, and the number of LEDs connected to the circuit varies accordingly when the voltage fluctuates after rectification, so as to keep the voltage across the two terminals of an LED light string approximately consistent with an input voltage all the time; and as for the other type, a rectifier bridge is formed by four LEDs according to the forward-on and reverse-off characteristics of the LEDs, and when a network voltage passes through the rectifier bridge formed by the LEDs, power is directly supplied to two LEDs.

### Technical Solution of the Invention

A linear constant-current LED drive circuit adaptive to a wide voltage range comprises:

A rectifier bridge, wherein the rectifier bridge is a full-wave rectifier bridge used for full-wave rectification of the waveform of an 85V-265V/50 Hz sinusoidal voltage and is connected with a filter circuit and a high-voltage stabilizing and dropping circuit through wires;

The filter circuit, wherein the filter circuit is used for filtering to convert a full-wave pulsating voltage output by the rectifier bridge into a direct-current voltage and is connected with a constant-current source circuit through a wire;

The constant-current source circuit, wherein the constant-current source circuit is used for limiting a current across LED loads and providing a constant-current power supply for LED lights and is connected with a switch array circuit through a wire;

The switch array circuit (4), wherein the switch array circuit is used for switching series-parallel connection modes of LED light strings and constant-current branches of the constant-current source circuit by means of the switching characteristics of LDMOSs when an external voltage varies; and

The high-voltage stabilizing and dropping circuit (5), wherein the high-voltage stabilizing and dropping circuit is used for providing a working voltage for low-voltage modules.

A diode on each bridge arm of the rectifier bridge has a reverse withstand voltage over 800V and a forward current capacity over 500 mA.

The filter circuit is composed of an electrolytic capacitor.

The constant-current source circuit has four constant-current branches, and a CRD with a constant current across both terminals is connected to each constant-current branch in series.

The switch array circuit includes a light string LED1, a light string LED2, a light string LED3, a light string LED4, an LDMOS1, an LDMOS2, an LDMOS3, an LDMOS4, an LDMOS5, an LDMOS6, an LDMOS7, an LDMOS8, an LDMOS9, a Gate drive1, a Gate drive2, a Gate drive3, a Gate drive4, a Gate drive5, and a Gate drive6, wherein the light string LED1 has a forward terminal connected to a reverse terminal of a CRD1, as well as a reverse terminal connected to a drain of the LDMOS1 and a drain of the LDMOS4; the light string LED2 has a forward terminal connected to a source of the LDMOS1, a source of the LDMOS7, a floating VS1 of the Gate drive1, and a floating VS4 of the Gate drive4, as well as a reverse terminal connected to a drain of the LDMOS2 and a drain of the LDMOS5; the light string LED3 has a forward terminal connected to a source of the LDMOS8, a source of the LDMOS2, a floating VS2 of the Gate drive2, and a floating VS5 of the Gate drive5, as well as a reverse terminal connected to a drain of the LDMOS3 and a drain of the LDMOS6; the light string LED4 has a forward terminal connected to a source of the LDMOS3, a source of the LDMOS9, a floating VS3 of the Gate drive3, and a floating VS6 of the Gate drive6 and a grounded reverse terminal; a source of the LDMOS4, a source of the LDMOS5, and a source of the LDMOS6 are all grounded; a gate of the LDMOS1, a gate of the LDMOS2, a gate of the LDMOS3, a gate of the LDMOS7, a gate of the LDMOS8, and a gate of the LDMOS9 are respectively connected to HO1, HO2, HO3, HO4, HO5, and HO6 of the Gate drives; and an input voltage VDD of the Gate drives is connected to an output voltage VDD of the high-voltage stabilizing and dropping circuit.

The circuit structure of the high-voltage stabilizing and dropping circuit is as follows: R1 provides a gate voltage for an LDMOS10 and is connected to a drain of an LDMOS11, R7 and C1 are connected to a source of the LDMOS10 in series, a drain of the LDMOS10 is connected to an input voltage, a source of the LDMOS11 is grounded, a voltage across two terminals of C1 is stabilized by R6 and Z1, R3 is connected to a forward terminal of a comparator COM1 in series, R2 is connected to an output terminal and an in-phase terminal of the comparator, a reverse terminal of the comparator is connected to a reference voltage Vref2 output by a pre-reference voltage source, the output terminal of the comparator COM1 is connected to a gate of the LDMOS11, a resistor R4 and a resistor R5 of a resistance feedback network are connected to a drain of a power transistor M1 in series, a source of the power transistor M1 is connected to a capacitor voltage VCC, a voltage drop is fed back to an in-phase terminal of an operational amplifier OPA1 by the resistor R5, a reverse terminal of the operational amplifier is connected to a band-gap reference voltage Vref1, and an output signal of the operational amplifier is connected to a gate of the power transistor M1.

### Beneficial Effects of the Invention

According to the linear constant-current LED drive circuit adaptive to a wide voltage range, after an 85-265V/50 Hz alternating current is input and rectified by the rectifier bridge, a high pulsating voltage is formed at two output terminals of the rectifier bridge, wherein the high pulsating voltage is a full-wave sinusoidal pulsating voltage having a peak value of 120-375V and a cycle of π, provides a working voltage for the high-voltage stabilizing and dropping circuit, and also serves as an input voltage of an LED light source; the high-voltage stabilizing and dropping circuit provides a working voltage for low-voltage modules such as the Gate drives which in turn drive the LDMOS1, the LDMOS2, the LDMOS3, the LDMOS7, the LDMOS8, and the LDMOS9 having a high voltage across the sources; a direct-current voltage V is obtained after the pulsating voltage is processed by a filter; the nine LDMOSs in the switch array circuit are controlled by two external enablers EN1 and EN2 to respectively correspond to a threshold voltage V1 and a threshold voltage V2; in the case of 120≤V<V1, EN1 controls the LDMOS2 to be turned off and controls the LDMOS5 and the LDMOS8 to be turned on, and EN2 controls the LDMOS1 and the LDMOS3 to be turned off and controls the LDMOS4, the LDMOS6, the LDMOS7, and the LDMOS9 to be turned on, and at this moment, the CRD1, the light string LED1 and the LDMOS4 constitute a first branch, a CRD2, the LDMOS7, the light string LED2, and the LDMOS5 constitute a second branch, a CRD3, the LDMOS8, the light string LED3, and the LDMOS6 constitute a third branch, a CRD4, the LDMOS9 and the light string LED4 constitute a fourth branch, and the four branches are connected in parallel; in the case of V1≤V<V2, EN1 controls the LDMOS2 to be turned off and controls the LDMOS5 and the LDMOS8 to be turned on, EN2 controls the LDMOS4, the LDMOS6, the LDMOS7, and the LDMOS9 to be turned off and controls the LDMOS1 and the LDMOS3 to be turned on, at this moment, the CRD1, the light string LED1, the LDMOS1, the light string LED2, and the LDMOS5 constitute a first branch, and the CRD3, the LDMOS8, the light string LED3, the LDMOS3, and the light string LED4 constitute a second branch, and the two branches are connected in parallel; and in the case of V2≤V<375V, EN1 controls the LDMOS5 and the LDMOS8 to be turned off and controls the LDMOS2 to be turned on, EN2 controls the LDMOS4, the LDMOS6, the LDMOS7 and the LDMOS9 to be turned off and controls the LDMOS1 and the LDMOS3 to be turned on, and at this moment, the CRD1 the light string LED1, the LDMOS1, the light string LED2, the LDMOS2, the light string LED3, the LDMOS3 and the light string LED4 constitute a loop. The number of LEDs connected in series to each LED load is optimized to make sure that the CRD voltage on each constant-current branch can reach a constant-current turn-on current, so that the current output by the filter circuit is limited to the rated current value of the LEDs when passing across each LED load via the corresponding CRD; and the LEDs have a voltage clamp function when turned on forward, so that the part of the voltage V exceeding the forward turn-on voltage of the LED light strings is all applied to the CRDs.

### Compared with the Prior Art, The Invention has the Following Advantages

The circuit can be directly applied to a mains supply and can adapt to a wide alternating-current input voltage range.

The circuit is segmented in a manner different from that of all circuits on the present market to make sure that all LEDs can operate at the same time.

The circuit is free of high-frequency electromagnetic interference, good in stability and long in service life, and solves the technical problem of waste caused by insufficient utilization of LEDs of the two types of segmented linear constant-current LED drive power supplies, mentioned in the prior art, which are respectively designed as follows: as for one type, an LED array is segmented by means of the voltage clamp function of LEDs when the LEDs are turned on forward, and the number of LEDs connected to the circuit varies accordingly when the voltage fluctuates after rectification, so as to keep the voltage across the two terminals of an LED light string approximately consistent with an input voltage all the time; and as for the other type, a rectifier bridge is formed by four LEDs according to the forward-on and reverse-off characteristics of the LEDs, and when a network voltage passes through the rectifier bridge formed by the LEDs, power is directly supplied to two LEDs.

### BRIEF DESCRIPTION OF THE SEVERAL VIEWS OF THE DRAWINGS

The sole FIGURE is a structural diagram of the invention.

### DETAILED DESCRIPTION OF THE INVENTION

A linear constant-current LED drive circuit adaptive to a wide voltage range comprises:

A rectifier bridge 1, wherein the rectifier bridge is a full-wave rectifier bridge used for full-wave rectification of the waveform of an 85V-265V/50 Hz sinusoidal voltage and is connected with a filter circuit and a high-voltage stabilizing and dropping circuit through wires;

The filter circuit 2, wherein the filter circuit is used for filtering out high-frequency components in a pulsating voltage obtained after rectification and is composed of an electrolytic capacitor to realize filtering;

A constant-current source circuit 3, wherein the constant-current source circuit is used for limiting a current across LED light string loads and providing a constant-current power supply for LED lights and has four branches, and each branch comprises a CRD with a constant current across both terminals; the CRDs have a wide constant-current voltage range, and LEDs have a voltage clamp function, so that when an input alternating-voltage varies within a wide range, almost all fluctuations of an output voltage of the rectifier bridge are fed back to the two terminals of the CRDs, thus, basically keeping the voltage and current across the two terminals of each LED constant;

A switch array circuit (4), wherein the switch array circuit is used for switching the series-parallel connection modes of LED light strings and the constant-current branches of the constant-current source circuit by means of the switching characteristics of LDMOSs when an external voltage varies;

The switch array circuit is composed of LED light strings, LDMOSs, and gate drives. When the external voltage varies, the series-parallel connection modes of the LED light strings are switched by means of the switching characteristics of the LDMOSs. LED light strings are generally connected in series or parallel in three manners: four LED light strings are connected in series; two LED light strings are connected in series, and two LED light strings are connected in parallel; and four LED light strings are connected in parallel. Particularly, when the external voltage is high, the four LED light strings are connected in series to operate, and in this case, only a high forward turn-on voltage is obtained. When the external voltage is low, the four LED light strings are connected in parallel to operate, and in this case, only a low forward turn-on voltage is needed. When the external voltage is medium, two LED light strings are connected in series, and the other two LED light strings are connected in parallel, so that the LED light strings can work within a wide voltage range. The gate drives are used for driving the high-voltage LDMOSs having ungrounded sources;

The high-voltage stabilizing and dropping circuit 5, wherein the high-voltage stabilizing and dropping circuit charges an RC circuit by means of the high-voltage LDMOSs and obtains a stable output voltage through a linear voltage stabilizing circuit to provide a working voltage for low-voltage modules.

The high-voltage stabilizing and dropping circuit is mainly composed of LDMOSs and a capacitor. A voltage within a certain range is obtained at two terminals of the capacitor and is stabilized by a Zener stabilivolt to obtain a stable voltage supplied to a band-gap pre-reference voltage source and a linear voltage regulator, and an output voltage of the band-gap pre-reference voltage source has a small temperature drift coefficient and a high power supply rejection ratio and is used as a reference voltage of the linear voltage stabilizer. The voltage across the two terminals of the capacitor is used as an input voltage of the linear voltage stabilizer which is formed by a regulation tube, resistant feedback networks, and an operational amplifier, so that a stable output voltage is obtained, a high load capacity is achieved, and a working voltage is provided for the low-voltage modules.

The technical solution of the invention is detailed below with reference to the sole FIGURE.

The rectifier bridge is a full-wave rectifier bridge used for full-wave rectification of the waveform of an 85V-265V/50 Hz sinusoidal voltage, is connected with the filter circuit (2) through a wire and is connected with the high-voltage stabilizing and dropping circuit (5) through a wire, and a diode on each bridge arm of the rectifier bridge has a reverse withstand voltage over 800V and a forward current capacity over 500 mA.

The filter circuit 2 is mainly composed of a capacitor C0, is used for filtering to convert a full-wave pulsating voltage output by the rectifier bridge into a direct-current voltage, and is connected with the constant-current source circuit 3 through a wire. According to the circuit structure of the filter circuit, the electrolytic capacitor C0 is connected to an output voltage of the rectifier bridge.

The constant-current source circuit 3 mainly has four two-terminal constant-current modules CRD1, CRD2, CRD3, and CRD4 and is used for limiting a current across LED loads and providing a constant-current power supply for LED lights. The constant-current value of the CRDs is determined by the rated current of the LED loads, and the range of the constant-current voltage is determined by the effective value range of an input alternating-current voltage required by a product and the number of the LED loads. The number of series-connected LEDs is adjusted to enable the voltage across the two terminals of the CRDs to be greater than the initial constant-current voltage to make sure that the current across the LEDs is close to the rated current, thus, realizing constant-current driving. The LEDs have a voltage clamp function when turned on forward, so that the part of the input voltage V exceeding the forward turn-on voltage of the LED light strings will be fed back to the CRDs, and over-voltage of the LEDs is avoided. The constant-current source circuit 3 is connected with the switch array circuit 4 through a wire. According to the circuit structure of the constant-current source circuit 3, forward terminals of all CRDs are connected to the input voltage V, a reverse terminal of CRD1 is connected to a forward terminal of a light string LED1, a reverse terminal of CRD2 is connected to a drain of an LDMOS7, a reverse terminal of CRD3 is connected to a drain of an LDMOS8, and a reverse terminal of CRD4 is connected to a drain of an LDMOS9.

The switch array circuit 4 mainly includes a light string LED1, a light string LED2, a light string LED3, a light string LED4, an LDMOS1, an LDMOS2, an LDMOS3, an LDMOS4, an LDMOS5, an LDMOS6, an LDMOS7, an LDMOS8, an LDMOS9, a Gate drive1, a Gate drive2, a Gate drive3, a Gate drive4, a Gate drive5, and a Gate drive6, wherein the LDMOS1 is controlled by HO1 which is controlled by an external enabler EN2, the LDMOS2 is controlled by HO2 which is controlled by an external enabler EN1, the LDMOS3 is controlled by HO3 which is controlled by the external enabler EN2, the LDMOS4 and the LDMOS6 are controlled by the external enabler EN2, the LDMOS5 is controlled by the external enabler EN1, the LDMOS7 is controlled by HO4 which is controlled by the external enabler EN2, the LDMOS8 is controlled by HO5 which is controlled by the external enabler EN1, the LDMOS9 is controlled by HO6 which is controlled by the external enabler EN2, that is to say, all the LDMOSs are controlled by the external enabler EN1 or the external enabler EN2; and the two external enablers EN1 and EN2 respectively correspond to a threshold voltage V1 and a threshold voltage V2, and V1 and V2 are determined by the constant-current voltage range of the CRDs and the number of LED lights. In the case of 120≤V<V1, EN1 controls the LDMOS2 to be turned off and controls the LDMOS5 and the LDMOS8 to be turned on, and EN2 controls the LDMOS1 and the LDMOS3 to be turned off and controls the LDMOS4, the LDMOS6, the LDMOS7, and the LDMOS9 to be turned off, and at this moment, the CRD1, the light string LED1, the LDMOS4, the CRD2, the LDMOS7, the light string LED2, the LDMOS5, the CRD3, the LDMOS8, the light string LED3, the LDMOS6, the CRD4, the LDMOS9 and the light string LED4 constitute four branches which are connected in parallel; in the case of V1≤V<V2, EN1 controls the LDMOS2 to be turned off and controls the LDMOS5 and the LDMOS8 to be turned on, EN2 controls the LDMOS4, the LDMOS6, the LDMOS7, and the LDMOS9 to be turned off and controls the LDMOS1 and the LDMOS3 to be turned on, at this moment, the CRD1, the light string LED1, the LDMOS1, the light string LED2, the LDMOS5, the CRD3, the LDMOS8, the light string LED3, the LDMOS3, and the light string LED4 constitute two branches which are connected in parallel; and in the case of V2≤V<375V, EN1 controls the LDMOS5 and the LDMOS8 to be turned off and controls the LDMOS2 to be turned on, EN2 controls the LDMOS4, the LDMOS6, the LDMOS7, and the LDMOS9 to be turned off and controls the LDMOS1 and the LDMOS3 to be turned on, and at this moment, the CRD1, the light string LED1, the LDMOS1, the light string LED2, the LDMOS2, the light string LED3, the LDMOS3, and the light string LED4 constitute a loop. The circuit structure of the switch array circuit is as follows: the light string LED1 has a forward terminal connected to a reverse terminal of the CRD1, as well as a reverse terminal connected to a drain of the LDMOS1 and a drain of the LDMOS4; the light string LED2 has a forward terminal connected to a source of the LDMOS1, a source of the LDMOS7, a floating VS1 of the Gate drive 1 and a floating VS4 of the Gate drive 4, as well as a reverse terminal connected to a drain of the LDMOS2 and a drain of the LDMOS5; the light string LED3 has a forward terminal connected to a source of the LDMOS8, a source of the LDMOS2, a floating VS2 of the Gate drive2 and a floating VS5 of the Gate drive5, as well as a reverse terminal connected to a drain of the LDMOS3 and a drain of the LDMOS6; the light string LED4 has a forward terminal connected to a source of the LDMOS3, a source of the LDMOS9, a floating VS3 of the Gate drive3, and a floating VS6 of the Gate drive6 and a grounded reverse terminal; a source of the LDMOS4, a source of the LDMOS5, and a source of the LDMOS6 are all grounded; a gate of the LDMOS1, a gate of the LDMOS2, a gate of the LDMOS3, a gate of the LDMOS7, a gate of the LDMOS8, and a gate of the LDMOS9 are respectively connected to HO1, HO2, HO3, HO4, HO5, and HO6 of the Gate drives; and an input voltage VDD of the Gate drives is connected to an output voltage VDD of the high-voltage stabilizing and dropping circuit.

According to the high-voltage stabilizing and dropping circuit 5, an RC circuit is formed by an LDMOS10 and a capacitor C1, a voltage VCC across the two terminals of the capacitor serves as a detection signal of a hysteresis comparator COM1, and two different threshold voltage values can be obtained by regulating the resistances of R2 and R3 to serve as preset voltage values for detecting a VCC fluctuation voltage. After the high-voltage stabilizing and dropping circuit 5 is powered on, no control signal is transmitted to a gate of an LDMOS11, the LDMOS11 is in an off state, R1 provides a bias voltage for the LDMOS10, a gate of the LDMOS10 is on a high level, the LDMOS10 is turned on, and a high direct-current pulsating voltage passes through the LDMOS10 to charge the RC circuit. When the voltage VCC across the two terminals of the capacitor C1 reaches the preset voltage values, a detection signal controls the gate of the LDMOS11, so that the LDMOS11 is turned on. At this moment, an external input voltage passes through the resistor R1, and the LDMOS11 to be grounded to form a loop, the gate of the LDMOS10 is pulled to a low level to be switched to an off state, and the RC circuit is turned off. When the voltage is consumed by loads which are lower than a certain value, the detection signal controls the LDMOS11 to be in an off state, at this moment, the LDMOS10 is turned on again, the RC circuit is activated again to charge the capacitor, and the working state is repeated as mentioned above, so that the voltage across the two terminals of the capacitor varies within a certain range. The voltage VCC is processed by the resistor R6 and a Zener diode Z1 to obtain a stable voltage which enables a pre-reference voltage source Pre-BAG and an operational amplifier OPA1 to work, Vref1 generated by the pre-reference voltage source is used as a reference voltage of OPA1, OPA1 regulates the gate voltage of M1 according to changes of a feedback voltage of R5 to keep the output voltage VDD stable, and thus, a working voltage is provided for the gate drives. The circuit structure of the high-voltage stabilizing and dropping circuit is as follows: R1 provides a gate voltage for the LDMOS10 and is connected to the drain of the LDMOS11, R7 and C1 are connected to a source of the LDMOS10 in series, a drain of the LDMOS10 is connected to an input voltage, a source of the LDMOS11 grounded, the voltage across the two terminals of C1 are stabilized by R6 and Z1, R3 is connected to a forward terminal of the comparator COM1 in series, R2 is connected to an output terminal and an in-phase terminal of the comparator, a reverse terminal of the comparator is connected with a reference voltage Vref2 output by the pre-reference voltage source, the output terminal of COM1 is connected to the gate of LDMOS11, a resistor R4 and a resistor R5 of a resistance feedback network are connected to a drain of a power transistor M1 in series, a source of the power transistor is connected with a capacitor voltage VCC, a voltage drop is fed back to the in-phase terminal of the operational amplifier OPA1 by the resistor R5, a reverse terminal of the operational amplifier is connected to a band-gap reference voltage Vref1, and an output signal of the operational amplifier is connected to a gate of the power transistor M1.

1. A linear constant-current LED drive circuit adaptive to a wide voltage range, comprising:
a rectifier bridge, wherein the rectifier bridge is a full-wave rectifier bridge used for full-wave rectification of a waveform of an 85V-265V/50 Hz sinusoidal voltage and is connected with a filter circuit and a high-voltage stabilizing and dropping circuit through wires;
the filter circuit, wherein the filter circuit is used for filtering to convert a full-wave pulsating voltage output by the rectifier bridge into a direct-current voltage and is connected with a constant-current source circuit through a wire;
the constant-current source circuit, wherein the constant-current source circuit is used for limiting a current across LED loads and providing a constant-current power supply for LED lights and is connected with a switch array circuit through a wire;
the switch array circuit, wherein the switch array circuit is used for switching series-parallel connection modes of LED light strings and constant-current branches of the constant-current source circuit by means of switching characteristics of LDMOSs when an external voltage varies; and
the high-voltage stabilizing and dropping circuit, wherein the high-voltage stabilizing and dropping circuit is used for providing a working voltage for low-voltage modules.

2. The linear constant-current LED drive circuit adaptive to a wide voltage range according to claim 1, wherein a diode on each bridge arm of the rectifier bridge has a reverse withstand voltage over 800V and a forward current capacity over 500 mA.

3. The linear constant-current LED drive circuit adaptive to a wide voltage range according to claim 1, wherein the filter circuit is composed of an electrolytic capacitor.

4. The linear constant-current LED drive circuit adaptive to a wide voltage range according to claim 1, wherein the constant-current source circuit has four constant-current branches, and a CRD with a constant current across both terminals is connected to each said constant-current branch in series.

5. The linear constant-current LED drive circuit adaptive to a wide voltage range according to claim 1, wherein the switch array circuit includes a light string LED1, a light string LED2, a light string LED3, a light string LED4, an LDMOS1, an LDMOS2, an LDMOS3, an LDMOS4, an LDMOS5, an LDMOS6, an LDMOS7, an LDMOS8, an LDMOS9, a Gate drive1, a Gate drive2, a Gate drive3, a Gate drive4, a Gate drive5, and a Gate drive6, wherein the light string LED1 has a forward terminal connected to a reverse terminal of a CRD1 as well as a reverse terminal connected to a drain of the LDMOS1 and a drain of the LDMOS4; the light string LED2 has a forward terminal connected to a source of the LDMOS1, a source of the LDMOS7, a floating VS1 of the Gate drive1 and a floating VS4 of the Gate drive4, as well as a reverse terminal connected to a drain of the LDMOS2 and a drain of the LDMOS5; the light string LED3 has a forward terminal connected to a source of the LDMOS8, a source of the LDMOS2, a floating VS2 of the Gate drive2 and a floating VS5 of the Gate drive5, as well as a reverse terminal connected to a drain of the LDMOS3 and a drain of the LDMOS6; the light string LED4 has a forward terminal connected to a source of the LDMOS3, a source of the LDMOS9, a floating VS3 of the Gate drive3 and a floating VS6 of the Gate drive6 and a grounded reverse terminal; a source of the LDMOS4, a source of the LDMOS5 and a source of the LDMOS6 are all grounded; a gate of the LDMOS1, a gate of the LDMOS2, a gate of the LDMOS3, a gate of the LDMOS7, a gate of the LDMOS8, and a gate of the LDMOS9 are respectively connected to HO1, HO2, HO3, HO4, HO5, and HO6 of the Gate drives; and an input voltage VDD of the Gate drives is connected to an output voltage VDD of the high-voltage stabilizing and dropping circuit.

6. The linear constant-current LED drive circuit adaptive to a wide voltage range according to claim 1, wherein a circuit structure of the high-voltage stabilizing and dropping circuit is as follows: R1 provides a gate voltage for an LDMOS10 and is connected to a drain of an LDMOS11, R7 and C1 are connected to a source of the LDMOS10 in series, a drain of the LDMOS10 is connected to an input voltage, a source of the LDMOS11 is grounded, a voltage across two terminals of C1 is stabilized by R6 and Z1, R3 is connected to a forward terminal of a comparator COM1 in series, R2 is connected to an output terminal and an in-phase terminal of the comparator, a reverse terminal of the comparator is connected to a reference voltage Vref2 output by a pre-reference voltage source, the output terminal of the comparator COM1 is connected to a gate of the LDMOS11, a resistor R4 and a resistor R5 of a resistance feedback network are connected to a drain of a power transistor M1 in series, a source of the power transistor M1 is connected to a capacitor voltage VCC, a voltage drop is fed back to an in-phase terminal of an operational amplifier OPA1 by the resistor R5, a reverse terminal of the operational amplifier is connected to a band-gap reference voltage Vref1, and an output signal of the operational amplifier is connected to a gate of the power transistor M1.
